(19) United States
(12) Patent Application Publication
(10) Pub. No.: US 2006/0017256 A1
(43) Pub. Date: Jan. 26, 2006

(54) Torque reaction damper for a drive axle

(76) Inventor: Herbert L. Hupperich JR., Jackson, MS (US)

Correspondence Address: Richard C. Litman;LITMAN LAW OFFICES, LTD., P.O. Box 15035, Arlington, VA, 22215, US

(21) Appl. No.: 10/896,919

(22) Filed: Jul. 23, 2004

(51) Int. Cl. B60G 1/00

(52) U.S. Cl. 280/124.156

(57) ABSTRACT

The present torque reaction damper for a drive axle is a series of embodiments of installations and attachment bracketry for use in dirt track late model (DTLM) racing vehicles. Such cars are set up to provide relatively large vertical deflections of the solid rear drive axle, to drive the inboard wheel downwardly against the track surface for better traction and to shift the axle angularly to promote oversteer through the turns when the throttle is applied. The present torque reaction damper solves the problem of sudden “chassis drop” and its destabilizing effect, when the throttle is suddenly closed at the end of a straight before entering a turn. The present damper comprises a shock absorber installed either forwardly or rearwardly between the “bird cage” axle bracket and the chassis and serves to cushion the movement of the chassis when the throttle is closed, thereby facilitating car stability and control.

### BACKGROUND OF THE INVENTION

1. Field of the Invention

The present invention relates generally to automotive suspension systems, and more particularly to a shock absorber or damper installed between the chassis or frame and an attachment point on the axle of an automobile having a solid rear drive axle. The present damper is particularly suited for installation on a dirt track modified race car having extensive rear axle and rear suspension travel in order to dampen the sudden movement of the chassis relative to the axle during the transition from acceleration to deceleration.

2. Description of the Related Art

Innumerable suspension systems and geometries have been developed for automotive vehicles over the years. The most common type of rear suspension system used with front engine, rear drive vehicles has been the solid rear axle, in which the differential and left and right axle tubes or housings are cast or otherwise formed as a single unit with no relatively moving components. This type of rear drive system is relatively simple to manufacture, and the suspension systems generally utilized with such solid rear axles are also relatively straightforward.

Such solid rear axle drive systems have their drawbacks, however, principally in the form of a relatively large amount of unsprung weight. The entire mass of the two axles and the differential is moved by road surface irregularities, and requires a relatively large spring rate and shock absorbing system in order to control the movement of such a relatively large mass relative to the rest of the vehicle. Such solid axle systems are also not optimally suited for uneven terrain, as any lifting or tilting of one wheel simultaneously results in an equal tilt of the opposite wheel due to the rigid structure of the axle and the parallel planes in which the rear wheels rotate. As a result, most automotive manufacturers have gone to other types of drive and suspension systems, particularly for smaller and lighter automobiles.

The racing world is quite different from the everyday world of street driving, however. A multitude of different rules and sanctioning bodies controls innumerable different types of classes and vehicle configurations in automobile racing. Most of these classes are quite restrictive in their rules, and limit the cars to certain specific chassis, engine, and drive train types and configurations. This may be done for the purpose of economics, in an effort to cap the costs of preparing and racing a car in a given class, and/or to limit the number of modifications which can be done to the car by the owner or team in an effort to equalize competition. As a result, there are numerous racing classes which mandate the use of a front engine, rear drive chassis with a solid rear drive axle.

One such class is the dirt track late model (DTLM) series, in which the cars are built on tubular steel chassis or frames and covered by body panels loosely resembling larger or intermediate size production automobiles. The rules mandate that these cars have front engines and rear wheel drive, with the rear drive component being a unitary, solid rear axle and differential. Considerable freedom is provided in the rules of most sanctioning bodies, however, for the attachment or suspension of the rear axle and differential to the remainder of the chassis.

Racers have taken advantage of this in recent years, by setting up the suspension travel to allow considerable vertical movement and a limited amount of forward and aft movement of each side or end of the axle. This provides traction benefits on the relatively “loose” or low friction surface provided on the typical dirt or clay track, in comparison to pavement. The slip angle generally achieved on dirt or clay surfaces is considerably higher than that normally desired on pavement, as (1) tire wear is lower on such unpaved surfaces, and (2) by maintaining power through the turns, the drag developed by such slip angles can be overcome, with the car developing higher cornering speeds than would be the case with lower tire slip angles. This is readily apparent in dirt or clay track racing series for rear wheel drive cars, where the rear end of the car swings outwardly in the turns with the drive wheels angled somewhat inwardly, and throttle is applied to drive the car both forwardly and inwardly through the turn.

More recently, racers have found it possible to allow the rear axle to move considerably relative to the chassis, or more accurately for the chassis to move atop the rear axle, on dirt track late model (DTLM) cars. The typical rear axle suspension allows the rear axle to swing downwardly as the torque of the driveshaft drives the differential downwardly on acceleration in a typical rear differential. Racers have taken advantage of this effect, by providing considerable rear axle travel relative to the chassis. Thus, when the car is accelerated, the rear axle is driven downwardly relative to the chassis, with the effect being to lift the rear of the chassis (and its mass) relative to the rear axle. This results in a reaction of greater downward force on the rear axle during the lifting action, thereby providing an increase in traction to the rear tires.

The typical rear axle suspension system is by means of trailing arms on each side of the differential. The torque effect during acceleration causes the axle and chassis reactions described above, with the torque tending to drive the left rear wheel more downwardly than the right rear wheel. Due to the trailing arm suspension system, the left side of the axle tends to move downwardly and also forwardly relative to the chassis, due to the arcuate path of suspension travel dictated by the left trailing arm assembly. This causes the rear axle to shift its angular alignment to the right relative to the chassis, driving the rear of the car to the right. This is a desirable trait when cornering on the typical counterclockwise oval dirt track in the United States.

However, the above described suspension motions and results are undone when acceleration ceases, as when a driver approaches a turn at the end of a straightaway. When the driver suddenly closes the throttle, the drive torque to the rear axle is reduced to zero, and in fact some greatly reduced amount of torque is applied in the opposite direction due to compression braking by the engine. This results in the sudden termination of the chassis lift on the left side of the vehicle, with the chassis suddenly slamming down on the suspension. As one will appreciate, this action is extremely unsettling and destabilizing to the motion of the car.

Dirt track late model (DTLM) race car suspensions are generally provided with various springs, shock absorbers, and suspension linkages in order to alleviate these unwanted, and generally undamped, motions. However, the suspension systems developed must still allow the motion and action described above in order to allow the car to take the proper “set” when the driver applies throttle through the turn, in order to achieve maximum corner speeds. As a result, DTLM race car suspensions have heretofore not been able to be tuned or adjusted to soften this “chassis drop” problem upon throttle closure.

The present invention provides a solution to the above described problem by means of a torque reaction damper for the rear axle drive in DTLM cars. While the present invention is directed particularly to use in such DTLM race cars, it may have applications in other automotive venues as well. The torque damper of the present invention comprises a shock absorber installed between a point on the chassis or frame and an attachment point on the rear axle. Rather than operating primarily in the vertical plane, as with conventional shock absorbers, the present torque reaction damper is aligned in a generally horizontal plane (depending upon the attachment points and the specific location of the axle relative to the chassis at any given point). The torque reaction damper may be installed forward of the rear axle with relatively low compression and high rebound rates to dampen axle motion relative to the chassis as the shock strut extends, or may be installed rearward of the rear axle with relatively high compression and low rebound rates to accomplish the same effect. The compression and rebound rates of the shock absorber or strut are selected in accordance with the geometry of the installation, with relatively weak damping being desirable for axle extension or drop, and relatively strong damping being desirable to alleviate the “chassis drop” problem described further above.

A discussion of the related art of which the present inventor is aware, and its differences and distinctions from the present invention, are described below.

U.S. Pat. No. 4,334,696 issued on Jun. 15, 1982 to Carl-Ingvar A. Bergström, titled “Rear Wheel Mounting For Motor Vehicles With A Rigid Rear Axle,” describes a conventional solid rear axle assembly with left and right trailing arms. The trailing arms allow the axle to rotate within its attachments to the trailing ends of the arms. Thus, no control of torque is provided by this system. Bergström provides a triangular frame which is essentially immovably attached to the body at two points (excepting slight movement provided by resilient attachment fittings), with a pair of vertically separated arms extending from the fixed triangular frame to points above and below the rear axle. This arrangement transfers torque developed by the rear axle, to the body of the vehicle through the two essentially parallel arms and their attachment to the triangular frame. The present suspension system, also incorporates a triangular rear axle torque control brace, but the brace is rigidly attached to the rear axle and is only secured to the chassis at its forward end by a concentric spring and shock absorber assembly. Bergström does not disclose any form of generally horizontally disposed shock absorber for damping sudden movement of the rear of the chassis or frame toward the rear axle, as provided by the present invention.

U.S. Pat. No. 4,425,976 published on Jan. 17, 1984 to Sukeaki Kimura, titled “Small-Type Four-Wheel Automobile,” describes an integral engine, transmission, differential, and rear axle package installed on a trailing arm frame. The engine and axle are affixed to the frame, and cannot rotate relative thereto, due to engine torque. A single shock absorber extends between the rear of the trailing arm frame behind the differential, and the vehicle chassis or body. As the trailing arm frame is a rigid, generally rectangular structure pivotally attached to the chassis at two forwardly located, laterally separated points, the engine/transmission/differential/rear axle assembly cannot twist either laterally or vertically relative to the frame nor to the vehicle body, as is allowed by rear axle suspension systems employed in DTLM type race cars. Thus, Kimura has no motivation to provide any additional shock absorbing or torque damping means for such non-existent movement in his suspension system.

U.S. Pat. No. 4,641,854 issued on Feb. 10, 1987 to Tatsuo Masuda et al., titled “Wheel Suspension For A Vehicle,” describes an articulated rear drive system employing half shafts extending to each side of a differential which is positionally fixed in the chassis. A multilink rear suspension assembly is used to locate the rear wheel hub on each side. A single shock absorber extends between a point adjacent the wheel hub, upwardly and forwardly to a point on the chassis. It is noted that the Masuda et al. shock absorber system has a concentric coil spring installed therewith. Such a coil spring would tend to produce a relatively uniform rate of force as it is compressed or extended, unlike the present torque reaction damper, which provides the vast majority of its resistance in a direction to slow the drop of the chassis relative to the rear axle while remaining relatively free in the opposite direction. Moreover, Masuda et al. do not employ a solid rear axle, nor do they employ a generally parallel, rearwardly extending trailing arm assembly to locate the rear axle of their vehicle.

U.S. Pat. No. 4,730,838 issued on Mar. 15, 1988 to Hirotake Takahashi, titled “Motor Vehicle With Leveling Mechanisms,” describes a suspension system in which the rear axle is attached to a generally rectangular trailing arm frame, with the rear axle forming the rear lateral member of the frame. A single rearwardly disposed shock absorber with a concentric spring extends between the trailing arm assembly and the chassis or frame of the vehicle. The two point pivotal attachment of the rigid trailing arm frame to the chassis precludes any angular tilt of the rear axle in any plane relative to the chassis, unlike the suspension systems to which the present torque reaction damper invention is applied.

U.S. Pat. No. 4,799,708 issued on Jan. 24, 1989 to Akio Handa et al., titled “Off-Road Vehicle,” describes a relatively small, four-wheel all-terrain vehicle having a multilink rear suspension comprising an upper A-arm and a lower trailing arm. The vehicle does not utilize a solid rear axle, and no telescoping, forwardly oriented suspension members similar to the torque reaction damper of the present invention are disclosed by Handa et al. for their off-road vehicle.

U.S. Pat. No. 4,817,985 issued on Apr. 4, 1989 to Akito Enokimoto et al., titled “Rear Suspension For Off-Road Vehicle,” describes essentially the same vehicle configuration as that of the Handa et al. '708 U.S. Patent discussed immediately above. It is noted that Handa is also listed as a co-inventor in the Enokimoto et al. U.S. Patent, and the same assignee is shown in both patents.

U.S. Pat. No. 4,988,120 issued on Jan. 29, 1991 to Anthony V. Jones, titled “Chassis System For Race Vehicle With Wheelie Bars,” describes a suspension system for a solid rear drive axle, comprising an upper rearward and lower forward link connecting the axle bracket (commonly called a “birdcage” in dirt track racing) to the chassis or frame. A wheelie bar, as used in drag racing, extends rearwardly from the lower end of the axle bracket and has its midpoint attached to the rear of the chassis. The fixed lengths of the forward and rearward axle attachment arms preclude any fore and aft movement of the axle relative to the chassis, unlike the suspension system to which the present damper is adapted. The rigid alignment of the drive axle with the chassis in a drag racing vehicle is essential for uniform traction in a straight line. Thus, the Jones suspension with its wheelie bar teaches away from the relatively loose suspension system used in oval dirt track racing and to which the present damper is adapted.

U.S. Pat. No. 5,333,896 issued on Aug. 2, 1994 to Brad M. Creighton, titled “Bird Cage Type Suspension With Bearing Connected To Axle Tube,” describes an attachment bracket for a solid drive axle in a racing vehicle suspension system. Such rear axle attachment brackets are known as “bird cages,” as noted further above. The bird cage bracket described by Creighton includes a bearing between the attachment arms and the axle surrounding portion of the bracket. Thus, the drive axle could rotate freely within the bird cage bracket, if it were not for additional axle attachment and restraining components. The Creighton bird cage is commonly used on oval dirt track race cars in various divisions, according to the specific rules of the sanctioning body, division, and/or class. The suspension system disclosed, illustrated, and described herein makes use of a similar bird cage type axle attachment bracket. However, Creighton discloses only conventional, generally vertically mounted shock absorbers in his suspension system. The Creighton patent does not disclose many of the conventional components and assemblies used with such suspension systems, e.g., the forwardly extending differential attachment frame which is movably secured to the chassis to limit rotation of the drive axle due to torque. Moreover, Creighton is silent regarding any means of damping the sudden vertical movement of the drive axle as torque is removed from the axle when the throttle is closed. The present invention expands upon the vehicle suspension as basically disclosed in the Creighton patent, by providing a torque reaction damper which extends between the bird cage and the chassis and which serves to dampen or soften the sudden axle rise or “chassis drop” which occurs at the end of the straights on oval tracks when the driver suddenly closes the throttle to brake for the turn.

U.S. Pat. No. 5,458,359 issued on Oct. 17, 1995 to Larry A. Brandt, titled “Missing Link Swivel For Four-Link Rigid Axle Suspensions,” describes a solid axle rear suspension attached to the chassis by means of a series of four trailing and/or leading arms. Two of the arms are parallel to one another, but another pair of the arms is triangulated to serve as lateral links to preclude lateral movement of the axle. These triangulated arms attach to the differential by means of a swivel arm or bracket, or alternatively to different points on the axle and to the chassis by means of the swivel arm or bracket. This allows the axle to move freely upwardly and downwardly on each side to the limits of the suspension, while still precluding lateral movement of the axle. The rigid, non-telescoping trailing and leading arms attach directly to axle brackets (or to the swivel bracket mounted on the differential) and preclude any torque rotation of the axle, unlike dirt track late model (DTLM) racing vehicle suspensions to which the present torque reaction damper invention is applied.

U.S. Pat. No. 6,231,264 issued on May 15, 2001 to Ronald J. McLaughlin et al., titled “Torque Rod Bearing Assembly,” describes a lateral locator and torque rod assembly for a solid rear axle similar to that of the '359 U.S. Patent to Brandt, discussed immediately above. The McLaughlin et al. assembly differs in that the two arms pivot independently about a single sleeve, which, in turn, rotates in three degrees of freedom about a spherical joint. The basic geometry of the assembly is essentially the same as that of the McLaughlin et al. '359 U.S. Patent, with no telescoping or shock absorbing means provided in any of the various locator links disclosed.

U.S. Pat. No. 6,328,324 issued on Dec. 11, 2001 to E. Dale Fenton, titled “Air Ride Suspension System,” describes a combination leaf spring and pneumatic suspension system for a solid axle. A shock absorber is provided forward of the axle, at an upwardly and forwardly inclined angle. This system is for a trailer having a non-driven axle. Thus, there is no drive torque to consider in this arrangement. While the axle will develop torque under braking (assuming the wheels are provided with brakes), the non-rotary attachment of the axle to the leaf spring using U-bolts serves to prevent rotation of the axle relative to the rest of the structure. As the axle is fixed longitudinally due to its fixed attachment to the leaf spring, the forward end of which is pivotally secured to a chassis bracket, the single shock absorber does nothing to assist in damping any torque or longitudinal movement component of the axle, as is provided by the present torque reaction damper invention.

U.S. Pat. No. 6,435,530 issued on Aug. 20, 2002 to Robert J. Ackley, titled “Anti-Roll Mechanism For Vehicle Suspension System,” describes a torsion bar system which receives input from the opposite wheels at one end of the car. Differential suspension travel causes a torsion bar to twist, which resists the differential travel to resist body roll of the vehicle. The arms of the input lever are adjustable in length by the driver of the vehicle to allow the driver to adjust roll stiffness as desired at the end of the car where the Ackley device is installed. This device is inoperable on a solid axle, as the two wheels have no independent movement relative to one another on a solid drive axle.

U.S. Patent Publication No. 2002/84,615 published on Jul. 4, 2002, titled “Air Bag For Sprint Car,” describes several embodiments of pneumatic suspension systems for sprint cars having solid front and rear axles. In one embodiment, the pneumatic springs are attached to the rear axle brackets or “bird cages” which serve to attach the rear axle to the chassis or frame structure. However, no trailing arm suspension system is disclosed in this or other embodiments. In another embodiment, forwardly extending lever arms work against pneumatic springs at their forward ends. However, this embodiment is more closely related to the antitorque frame or bracket which is bolted to the differential in conventional solid axle race vehicle construction, than it is to the torque reaction damper of the present invention.

Japanese Patent No. 61-169,305 published on Jul. 31, 1986, titled “Suspension Device,” describes (according to the drawings and English abstract) a trailing arm suspension system in which the upper and lower arms apply compressive and tensile forces to hydraulic units at their chassis attachment ends. The hydraulic units are interconnected to allow fluid to flow therebetween, with flow restricted to dampen movement of the arms and therefore of the attached axle. This system essentially comprises a self-contained hydraulic shock absorber for the suspension system, rather than installing a separate shock absorber as a modular component of the suspension system. The '305 disclosure does not describe any form of hydraulic or other shock absorber for dampening chassis drop due to torque reaction when drive torque is suddenly reduced in a motor vehicle.

European Patent No. 630,796 published on Dec. 28, 1994, titled “Running Gear For Railway Vehicles,” describes (according to the drawings and English abstract) a railroad car suspension employing a generally horizontally disposed shock absorber in addition to the conventional vertical shock absorber(s). The horizontal shock absorber is said to dampen horizontal movement of the axle, but the conventional solid axle of a railroad car is restricted in all but vertical motion due to its mechanical attachment to the railroad car. No trailing arm suspension using “bird cage” axle attachments, is disclosed. In any event, the horizontal shock absorber attaches to the axle outboard of the wheel, which would not be practicable in a road or racing vehicle.

Finally, Japanese Patent 11-180,106 published on Jul. 6, 1999, titled “Structure Of Suspension For Automobile,” describes (according to the drawings and English abstract) a shock absorber attachment bracket welded to a solid axle by a pair of lateral welds along the axle. The remainder of the suspension system appears to be conventional, showing coil springs extending between spring perches welded to the axle, and the overlying chassis structure. No trailing arm rear axle suspension system is disclosed, nor does the '106 patent appear to disclose the rotational attachment of the solid rear axle to the suspension components by means of “bird cage” attachment brackets, as used in dirt track late model (DTLM) race cars.

None of the above inventions and patents, taken either singly or in combination, is seen to describe the instant invention as claimed. Thus a torque reaction damper for a drive axle solving the aforementioned problems is desired.

### SUMMARY OF THE INVENTION

The present torque reaction damper for a drive axle comprises a series of embodiments of forwardly and rearwardly extending shock absorbers or dampers, and various attachment configurations therefor. Each of the embodiments is adapted for installation in the rear suspension assembly of a solid drive axle vehicle, i.e., wherein the axle is a rigid unit or assembly having rotating axle shafts enclosed in a non-rotating axle tube and differential assembly or unit. More particularly, the present torque damper is adapted for installation with such a solid axle which is rotationally secured within a pair of opposed “bird cage” axle brackets, which are, in turn, secured to the chassis or frame by generally parallel trailing arms between the chassis and the trailing axle. The axle is prevented from rotating by an axle locator brace which is rigidly attached to the axle at the differential, and which extends forwardly to a spring and shock absorber attachment to the frame to allow limited rotation of the axle in the bird cage brackets.

This suspension system allows a relatively large amount of vertical movement of the axle, with the trailing arms on each side of the axle allowing each end of the axle to move upwardly and downwardly a different amount from the other. The geometry of the trailing arm suspension system results in the end of the axle, which travels further downward, also moving somewhat forward in the chassis. This results in the axle positioning itself at an angle across the chassis, which results in the two drive wheels driving at an angle, rather than being parallel to the longitudinal axis of the chassis. The lower wheel is toed-in to some extent, i.e., driving inwardly toward the chassis, while the higher wheel is toed outwardly, driving away from the chassis.

In a dirt track late model (DTLM) race car, engine and drive line torque applied to the solid rear axle results in the left wheel being driven downwardly, and somewhat forwardly, relative to the right wheel. This produces some additional “bite” for the left tire, as it is forced downwardly against the underlying surface. The angular positioning of the axle also results in a misalignment of the drive wheels to the right, causing the car to tend to turn left. This is a desirable condition for the typical counterclockwise oval tracks nearly universally used in the United States for such racing. Power is applied as the driver establishes himself in the turn, which drives the left or inboard wheel downwardly against the surface and causes the chassis to lift on the inboard side. The angular displacement of the rear axle drives the rear of the car to the right or to the outside of the turn, causing the car to turn into the turn. In fact, the condition is sufficiently extreme that oversteer results, with the driver having to countersteer to the outside of the turn. Power continues to be applied as the car exits the turn to accelerate down the straight to the next turn.

The problem occurs when the driver closes the throttle to slow for turn entry to the next turn. At this point, the torque is reduced to zero, with engine braking and driveline friction resulting in some torque in the opposite direction. This sudden reduction of torque causes the chassis to slam downwardly on the previously high left side, which destabilizes the car at a point where stability is critical.

The present invention provides a solution to the above-described problem by means of a shock absorber or damper installed between at least one of the drive axle “bird cage” attachment brackets and the chassis. This torque reaction damper is disposed in a generally horizontal orientation, and may extend either forwardly or rearwardly to an attachment point on the chassis. Forwardly oriented dampers will extend upon chassis drop, with the rebound rate of the shock absorber or damper being set relatively high. Rearwardly oriented dampers are set up to have characteristics opposite those of forwardly installed dampers, with relatively high compression rates and relatively low rebound or extension rates. A series of different brackets for attaching the shock absorber(s) to the chassis is also disclosed herein.

These and other features of the present invention will become readily apparent upon consideration of the following specification and drawings.

### BRIEF DESCRIPTION OF THE DRAWINGS

FIG. 1 is a side elevation view of a first embodiment installation of a torque reaction damper for a drive axle according to the present invention, showing its operation.

FIG. 2 is a simplified top plan view of the torque reaction damper installation of the present invention, showing further details thereof.

FIG. 3 is a side elevation view of a second embodiment of a torque reaction damper according to the present invention, with the shock absorber or damper extending rearwardly to a rearward mounting point on the chassis.

FIG. 4 is a detailed perspective view of the chassis attachment assembly for the shock absorber or damper installation of FIG. 1, showing details thereof.

FIG. 5 is a detailed perspective view of an alternate shock absorber to chassis attachment assembly according to the present invention, showing various details thereof.

FIG. 6 is a detailed perspective view of another alternate shock absorber to chassis attachment assembly according to the present invention, showing various details thereof.

FIG. 7 is a detailed perspective view of a complete shock absorber, according to the present invention, installed between the chassis and the axle bird cage bracket, showing details of yet another attachment assembly embodiment and details of the bird cage bracket attachment.

Similar reference characters denote corresponding features consistently throughout the attached drawings.

### DETAILED DESCRIPTION OF THE PREFERRED EMBODIMENTS

The present invention comprises a series of embodiments of a torque reaction damper for softening or dampening the sudden “chassis drop” which occurs when the throttle is suddenly closed in driving a dirt track late model (DTLM) racing car. Such vehicles are required by their governing rules to have solid rear drive axles, i.e., axles comprising non-rotating left and right housings or sleeves extending from a generally centrally positioned differential, with the rear drive axle shafts rotating within the housings or sleeves. Such vehicles are generally set up to have intentionally “loose” rear suspensions for their solid drive axles in order to achieve certain benefits in traction when power is applied, as described further above. However, when power is suddenly reduced, as when approaching a turn, the result is sudden, destabilizing “chassis drop” with such suspension systems. Obviously, drivers can accommodate the chassis drop problem, but the sudden change in vehicle configuration does cost some time on the track as the driver is forced to adjust. The present damper or shock absorber eases this sudden change in configuration, making it easier for the driver to adjust to the change and therefore allowing the driver to carry more speed into the turn.

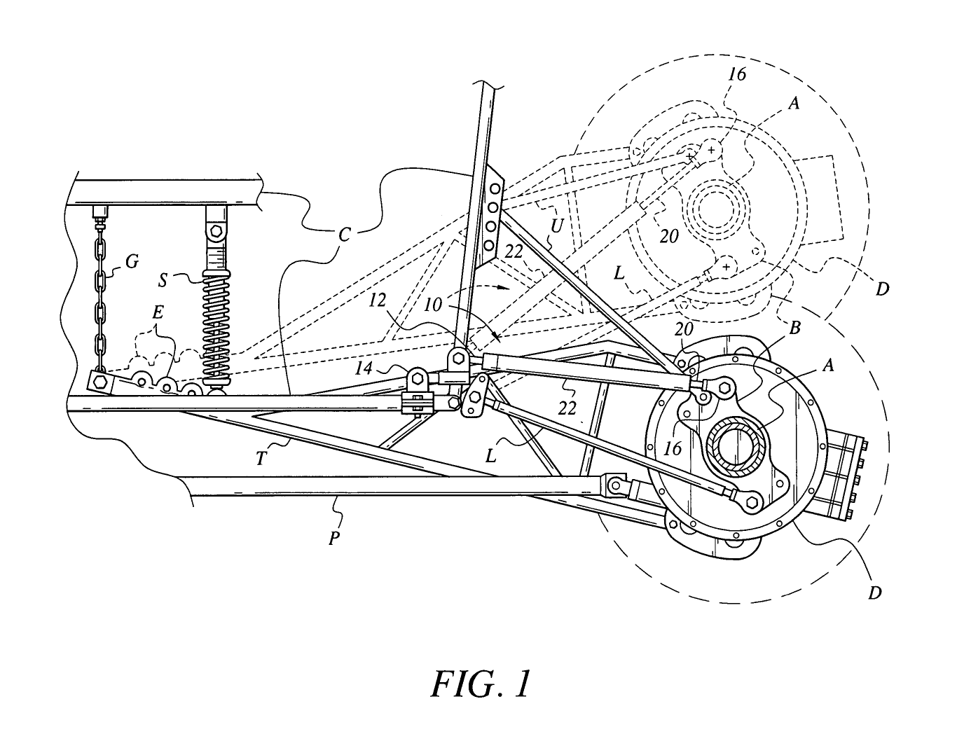

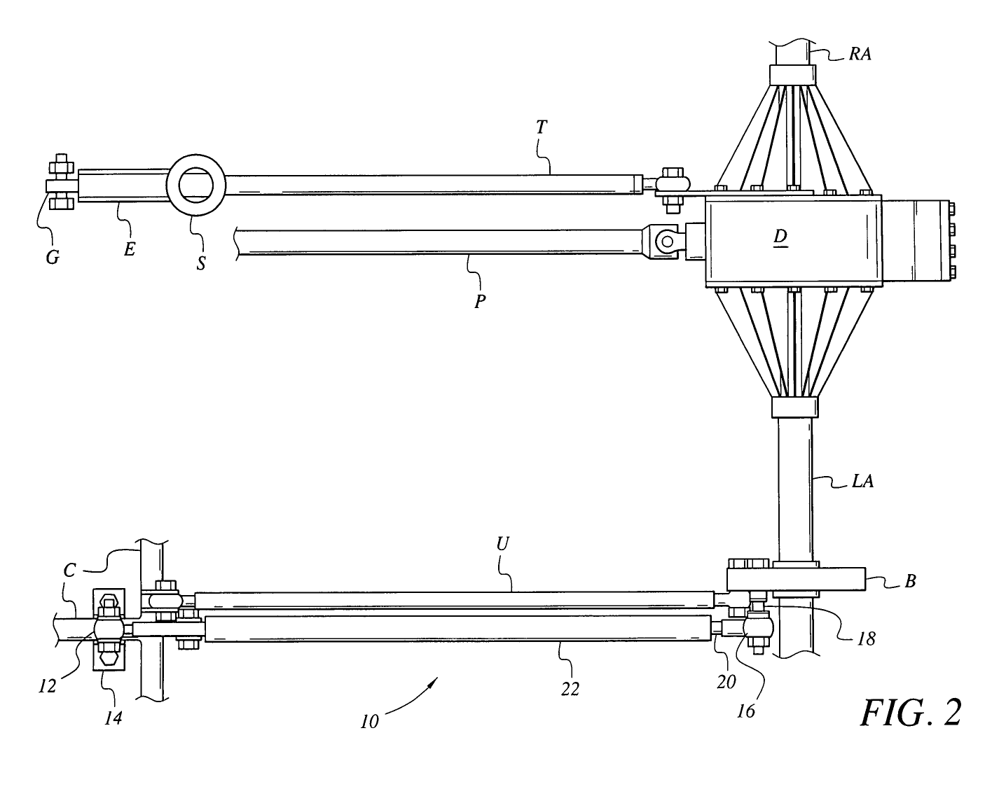

FIG. 1 is a left side elevation view of the lower rear portion of a DTLM car structure or chassis C, having a solid drive axle A with left and right sides or ends LA and RA (shown in FIG. 2) and central differential D installed in articulation with the chassis C. The axle A includes a pair of “bird cages” or axle attachment brackets installed thereon, with only the left side bird cage bracket B being shown in the drawings. It will be understood that the assembly is generally symmetrical, with the right side essentially being a mirror image of the assemblies shown in FIGS. 1 and 2. These bird cage brackets B have bearings between the brackets and their respective axle housings LA and RA. This allows the bird cage brackets B to rotate freely upon their respective axle housing sides LA and RA, or alternatively for the axle A to rotate within the bird cages B, if not restrained in some manner, as described further below.

A series of four articulating trailing arms articulate rearwardly from their respective attachment points on the chassis C and connect to respective attachment points on the two bird cage axle attachment brackets B. Again, due to the generally symmetry of the configuration, the right side has been omitted in the drawings. Only the left two trailing arms, i.e., the upper arm U and lower arm A, are shown in the drawing FIGS. connected to the illustrated bird cage axle bracket B on the left side axle housing tube LA, with it being understood that an essentially identical pair of arms is attached to an essentially identical bird cage bracket on the right side axle housing tube in a complete car. The upper and lower arms U and L may have different lengths, as any rotation imparted by the raising and lowering of the different length upper and lower arms U and L is accommodated by the relative rotation of the bird cage brackets B about the axle A. Lateral location of the axle is provided by a conventional lateral link (i.e., Panhard rod, not shown) extending from one side of the axle A to the opposite side of the chassis C. Other conventional components, e.g., shock absorbers and springs, etc., are not shown for clarity in the drawing FIGS.

Rotation of the axle assembly A within the bird cage brackets B is prevented by an axle locator brace or truss T which is immovably affixed (i.e., bolted) to the differential D and which extends forwardly therefrom. The forward end E of the brace or truss T is resiliently secured to the chassis or frame C by a “coil over” shock absorber and spring assembly S, i.e., a shock absorber having a coiled compression spring surrounding the cylindrical shock absorber body. A snubber or guard chain G is also connected between the chassis C and the forward end E of the axle locator brace or truss T, serving to prevent the forward end E of the brace or truss T from digging into the underlying surface in the event the shock absorber and spring assembly S becomes detached from the chassis C or the brace T.

The above described structure is generally conventional in DTLM race cars, and permits a relatively large amount of vertical movement in each side of the rear drive axle A, as is evident from the difference between the lower position of the axle A and its attached components shown in solid lines, and the upper position shown in broken lines in FIG. 1. In the left side view shown in FIG. 1, the wheel and tire rotate counterclockwise, which would drive the vehicle toward the left side of the drawing sheet. The torque reaction of the axle A is in the opposite direction of rotation, i.e., clockwise, with the relatively loose suspension setup of the axle A resulting in rotation of the axle A downwardly as it attempts to rotate clockwise about the trailing arm attachment points with the chassis C. This drives the wheel downwardly, to the general position shown in solid lines in FIG. 1 of the drawings. This torque effect is greater on the left side of the vehicle, as the axle A also tends to twist about its driveline or propeller shaft P. Given the rotation of conventional automotive engines, this tends to rotate the axle assembly counterclockwise when viewed from the rear of the car, i.e., driving the left wheel and tire further downwardly than the opposite side.

When power is suddenly reduced, this drive torque suddenly ceases, and in fact there is some relatively lesser torque applied in the opposite rotational direction due to engine compression braking and drive line friction. The result is that the axle A suddenly attempts to rotate in the opposite direction, i.e., counterclockwise, which tends to drive it upwardly relative to the chassis C as the axle A rotates about the trailing arm attachment points to the chassis C. In practice, the tires remain on (or close to) the surface, with the chassis C slamming down hard onto the rear suspension. This is the destabilizing torque reaction or “chassis drop” which the present invention prevents.

The present torque reaction damper comprises a telescoping cylindrical shock absorber 10 which is installed in a generally horizontal orientation (depending upon the position of the axle A relative to the chassis C) between the axle A, or more specifically the left side bird cage bracket B, and a point on the chassis C. In the exemplary installation shown in FIGS. 1 and 2, the chassis attachment end 12 of the shock absorber 10 is connected to the chassis C by an articulating, forwardly disposed chassis attachment bracket assembly 14 secured to the chassis C, with the rearwardly disposed bird cage axle bracket attachment end 16 of the shock strut 10 being pivotally connected to the bird cage axle bracket B by a lateral link assembly 18 (shown best in FIG. 2). Generally speaking, a single torque reaction damper strut 10 installed on the left side of the vehicle chassis between the left side bird cage bracket B and a point on the chassis C which is aligned longitudinally with the left side bracket B, is sufficient. The left side or end LA of the axle assembly A produces by far the greatest vertical movement relative to the chassis C due to the torque effects explained further above when power is applied, and thus the greatest chassis drop occurs on the left side of the vehicle.

It will be noted in FIG. 1, that the forwardly disposed shock absorber 10 is nearly completely compressed when the axle A is at its lowermost position, as shown in solid lines in FIG. 1. However, when chassis drop occurs, the extension rod 20 of the shock absorber 10 extends from the tubular body 22, as shown in the upwardly displaced assembly in broken lines in FIG. 1. Restriction of downward motion of the axle A is not particularly necessary, and in fact is not desired in most instances, as free downward motion of the left side tire relative to the chassis C tends to drive that tire more firmly against the underlying surface to provide greater traction or “bite.” Accordingly, the forwardly disposed torque reaction damper strut 10 of FIG. 1 is configured to provide relatively low resistance in compression, i.e., when the axle A moves from an upper position (broken lines) to a lower position (solid lines) relative to the chassis C. However, it is important that sudden upward movement of the axle A relative to the chassis C, i.e., chassis drop, be dampened. When this occurs with the forwardly mounted shock strut assembly 10 of FIGS. 1 and 2, the shock absorber 10 extends. Accordingly, the shock absorber 10 in its forwardly disposed installation as shown in FIGS. 1 and 2, is provided with considerably greater resistance to extension than to compression. The specific damping characteristics of the shock absorber in compression and extension may be tuned as desired, either at the time of manufacture of the shock absorber or by external adjustment of shock absorbers having such adjustability.

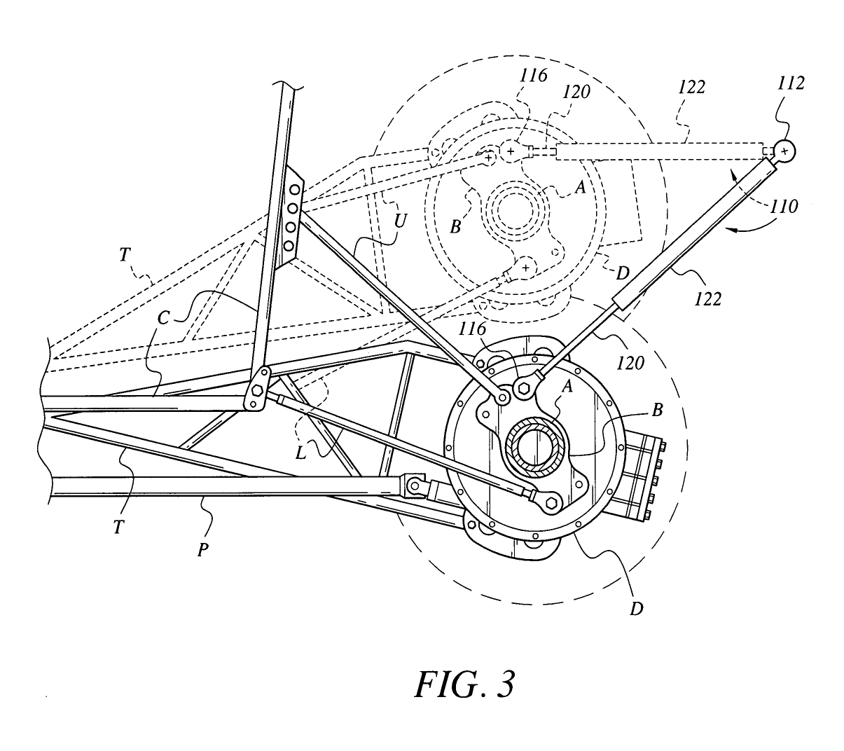

FIG. 3 of the drawings provides a left side elevation view of an alternative torque reaction damper installation, in which a shock absorber or strut 110 is installed to the rear of the axle A and its birdcage attachment bracket B. It will be noted that the conventional components of the vehicle shown in FIG. 3, e.g. the chassis C, axle A with its birdcage bracket B and differential D, upper and lower trailing arms U and L, etc., are essentially identical to those components illustrated in FIGS. 1 and 2. The only essential difference between the configuration shown in FIGS. 1 and 2 and the configuration shown in FIG. 3, is the location of the shock absorber 110 relative to the axle A, and the corresponding changes to the damping characteristics of the shock absorber 110 in accordance with its different extension and compression motions with axle movement in comparison to the system shown in FIG. 1.

In FIG. 3, the shock absorber 110 has its chassis attachment end 112 disposed rearwardly, attached to a rearwardly disposed mounting point (represented by the “+” in the center of the chassis attachment end 112 of the shock absorber 110) on the chassis. Conventionally, chassis structures extend somewhat rearwardly of the rear drive axle; this rearwardly extending structure is not shown in FIG. 3, for clarity in the drawing FIG. The opposite, birdcage bracket attachment end 116 of the shock strut 110 is secured to the birdcage bracket B in FIG. 3, rearwardly of the upper trailing arm U attachment to the bird cage bracket B. The shock absorber extension rod 120 extends generally rearwardly from the bird cage bracket attachment end 116 of the shock strut 110, with the cylindrical tubular body portion 122 connecting directly to the chassis attachment end 112 of the shock absorber assembly 110. It will be seen that the shock absorber 110 may be reversed end for end in the installation of FIG. 3, if so desired, just as the shock absorber 10 may be reversed in the installation shown in FIGS. 1 and 2.

It will be noted that the upper rear attachment of the chassis attachment end 112 of the shock absorber 110 in FIG. 3, results in the compression of the strut 110 as the rear axle A rises relative to the chassis C (or more correctly, as the chassis C settles on the axle A). As noted throughout the present disclosure, the present torque reaction damper invention serves to soften or slow this chassis drop, while still permitting the chassis C to rise freely relative to the axle A. Accordingly, the relative softness and firmness of the compression and extension strokes of the shock absorber 110 shown in the installation of FIG. 3, are reversed in comparison to the shock absorber 10 of FIGS. 1 and 2. In FIG. 3, the shock absorber 110 has a relatively soft extension stroke in order to allow the chassis C to rise freely relative to the axle A as power is applied and torque is developed. However, the compression stroke of the shock absorber 110 is relatively stiff, in order to dampen the chassis drop which occurs when the throttle is closed. An exemplary table of shock absorber compression and extension forces and actuation speeds is provided below.

TABLE I
ACTUATION VELOCITY V. COMPRESSION
AND REBOUND FORCES

| SHOCK ABSORBER | | | SHOCK ABSORBER | |
|---|---|---|---|---|
| 10, FIGS. 1 & 2 | | | 110, FIG. 3 | |
| | COMPRES- | EXTEN- | COMPRES- | EXTEN- |
| | SION | SION | SION | SION |
| SPEED, | FORCE, | FORCE, | FORCE, | FORCE, |
| IN/SEC. | LBS. | LBS. | LBS. | LBS. |
| 4.0 | 39 | 62 | 62 | 39 |
| 6.0 | 52 | 132 | 132 | 52 |
| 8.0 | 59 | 218 | 218 | 59 |
| 10.0 | 64 | 322 | 322 | 64 |
| 12.0 | 69 | 437 | 437 | 69 |

The above listed forces and actuation rates are exemplary and may be modified or adjusted as required, depending upon the specific installation and conditions (e.g. vehicle weight, suspension travel distances, mounting geometry, spring rates, track conditions, temperatures, etc.). It will be noted that the forces for the shock absorber 110 of FIG. 3 are exactly reversed from the forces for the shock absorber 10 of FIGS. 1 and 2. While in practice such precise reversal of forces is not likely to be achieved, nor may it be desired for different installations, the above table is exemplary for the two different installations and other values may be achieved, depending upon a large number of different factors. The primary point is that the shock absorber 10 installation of FIGS. 1 and 2 extends during chassis drop, and as a result requires relatively high damping forces to be developed during the extension process. Conversely, the shock absorber 110 of FIG. 3 compresses during chassis drop, thus requiring relatively high damping forces during the compression process.

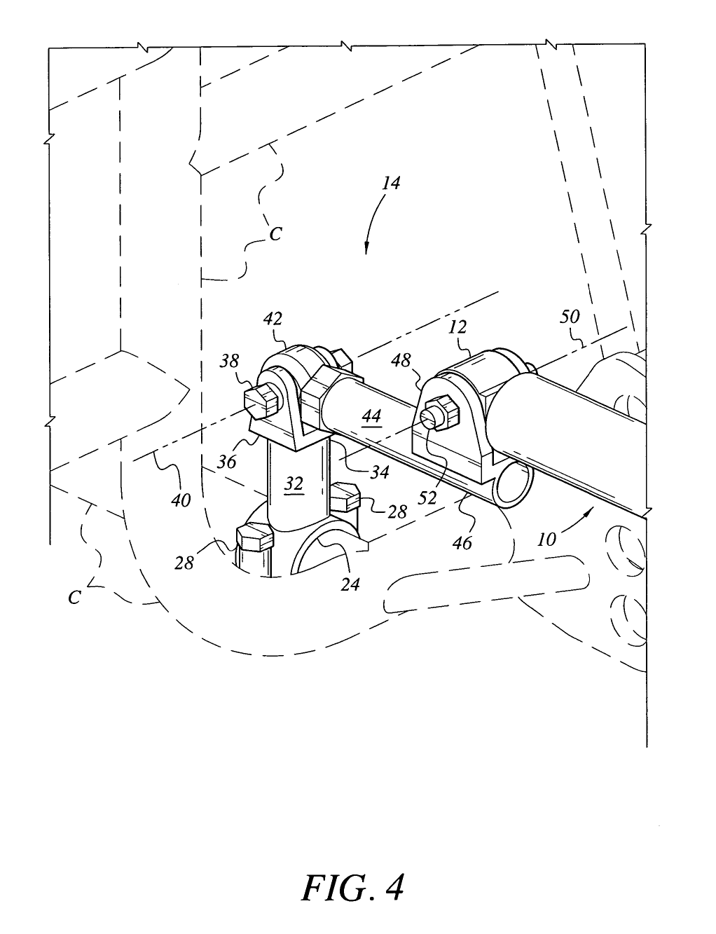

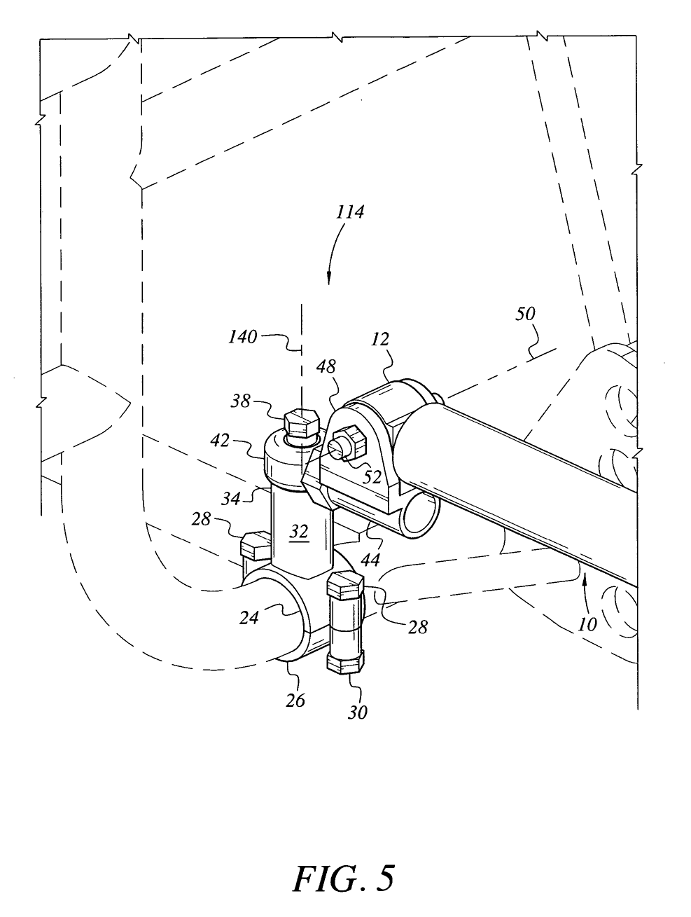

A number of different shock absorber mounting or attachment brackets may be used, depending upon the orientation of chassis members adjacent the attachment point for the shock absorber. FIGS. 4 through 7 illustrate a series of such different mounting bracket assemblies, with FIG. 4 providing a detailed perspective view of the chassis attachment bracket assembly 14 of the installation of FIGS. 1 and 2. The assembly 14 of FIGS. 1, 2, and 4 is configured for attaching to a generally horizontal and longitudinally oriented chassis tube or member. The assembly 14 comprises a first chassis clamp portion 24, configured to fit closely about the shape (round, square, etc.) of the tubular chassis member to which it is attached. A mating second clamp portion 26 (shown in FIG. 5 for the similar bracket assembly 114 illustrated in that FIG. ) fits against the opposite side of the chassis member, with the two clamp portions 24 and 26 being immovably affixed to one another and to the chassis member by a pair of opposed bolts 28 and nuts 30 (shown in FIG. 5). Alternatively, the bracket assembly 14 (and others) could be welded to the chassis structure, but this would of course preclude any positional adjustment for the brackets without destroying the weld.

An arm 32 extends radially from the first chassis clamp portion 24, with the distal end 34 of the arm 32 having a generally U-shaped rod end attachment fitting 36 affixed thereto. The two ears or lugs of the attachment fitting 36 include passages therethrough for a bolt 38, which forms a rod end attachment axis 40 normal to the rod end attachment fitting 36.

A spherical rod end 42 is pivotally installed upon the bolt 38 extending across the rod end attachment fitting 36, and secures concentrically into one end of a shock absorber attachment link 44. The link 44 includes a distal end 46 having a generally U-shaped shock absorber attachment fitting 48 extending laterally therefrom, with the fitting 48 having shock absorber attachment bolt passages formed through its two opposed lugs to define a shock absorber attachment axis 50. A shock absorber mounting bolt 52 passes through the two lugs or ears of the fitting 48, and secures the chassis attachment end 12 of the shock absorber 10 to the assembly 14. The spherical rod end 42 allows the attachment link 44 to pivot about the bolt 38 as the chassis moves relative to the axle, while also accommodating any relatively slight variations in alignment between the shock absorber 10 and the chassis C. It will be seen that the shock absorber attachment bracket assembly 14 may also be used to secure the chassis attachment end 112 of a rearwardly disposed shock absorber 110 to the chassis, depending upon the orientation of the chassis structure to which the shock absorber 110 is to be attached.

FIG. 5 provides a perspective view of a closely related shock absorber attachment fitting 114. The fitting 114 is configured for securing to a laterally disposed chassis member, rather than to a longitudinal member as in the case of the fitting 14 of FIGS. 1, 2, and 4. However, the basic attachment components of the fitting 114 are essentially identical to those of the fitting 14, comprising opposed first and second chassis clamp portions 24 and 26 secured to the chassis member and to one another by bolts 28 and nuts 30. A radial arm 32 extends from the first chassis clamp portion 24. However, rather than having a U-shaped bracket extending from the distal end thereof, the distal end 34 of the arm 32 of the assembly 114 includes a spherical rod end 42 pivotally secured directly thereto by a rod end attachment bolt 38 which passes concentrically through the central axis 140 of the rod end bearing 42 and the arm 32.

A relatively short shock absorber attachment link 44 is attached to the rod end bearing 42, and supports a shock absorber attachment fitting 48 extending laterally therefrom. The attachment fitting 48 defines a shock absorber attachment axis 50 passing thereacross, normal to the length of the shock absorber attachment link 44. A shock absorber attachment bolt 52 passes through the two opposed lugs of the fitting 48 to secure the chassis attachment end of the shock absorber 10 therebetween. As in the case of the shock absorber attachment bracket 14 described further above, the attachment bracket 114 may also be used to secure the rearwardly disposed chassis attachment end 112 of a shock absorber 110 to the chassis, depending upon the orientation of the chassis members to which the bracket 114 is to be attached.

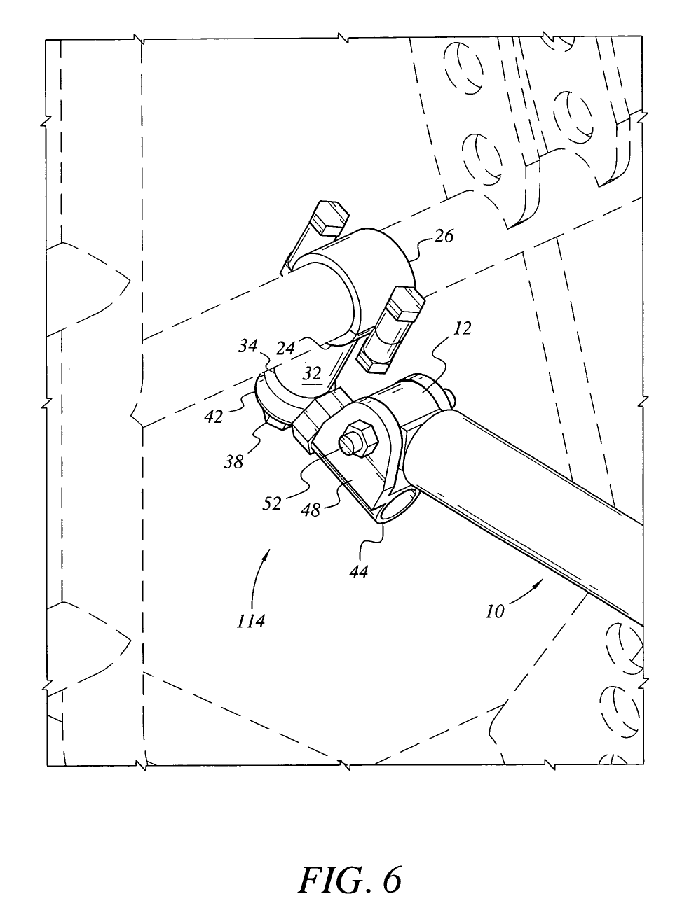

FIG. 6 illustrates another chassis attachment configuration for the present torque reaction damper invention. The chassis attachment bracket assembly 114 of FIG. 6 is identical to the bracket assembly 114 shown in FIG. 5, but is oriented differently, with its arm 32 extending generally downwardly rather than upwardly as shown installation of FIG. 5. The components are identical, comprising first and second chassis attachment clamp portions 24 and 26 secured to the chassis C by bolts 28 and nuts 30. The radial arm 32 includes a bolt 38 secured therein, holding a rod end bearing 42 to the distal end 34 of the arm 32. The rod end bearing 42 in turn holds a rod end attachment link 44 extending therefrom, with a shock absorber attachment bracket 48 extending radially from the link 44. The chassis attachment end 12 of the shock absorber 10 is secured to the bracket 48 by a bolt 52, as in the essentially identical chassis attachment bracket assembly 114 of FIG. 5. Either type of shock absorber 10 or 110, depending upon forward or rearward installation, may be used with the bracket 114 configuration of FIG. 6, again depending upon the orientation and positioning of the chassis members.

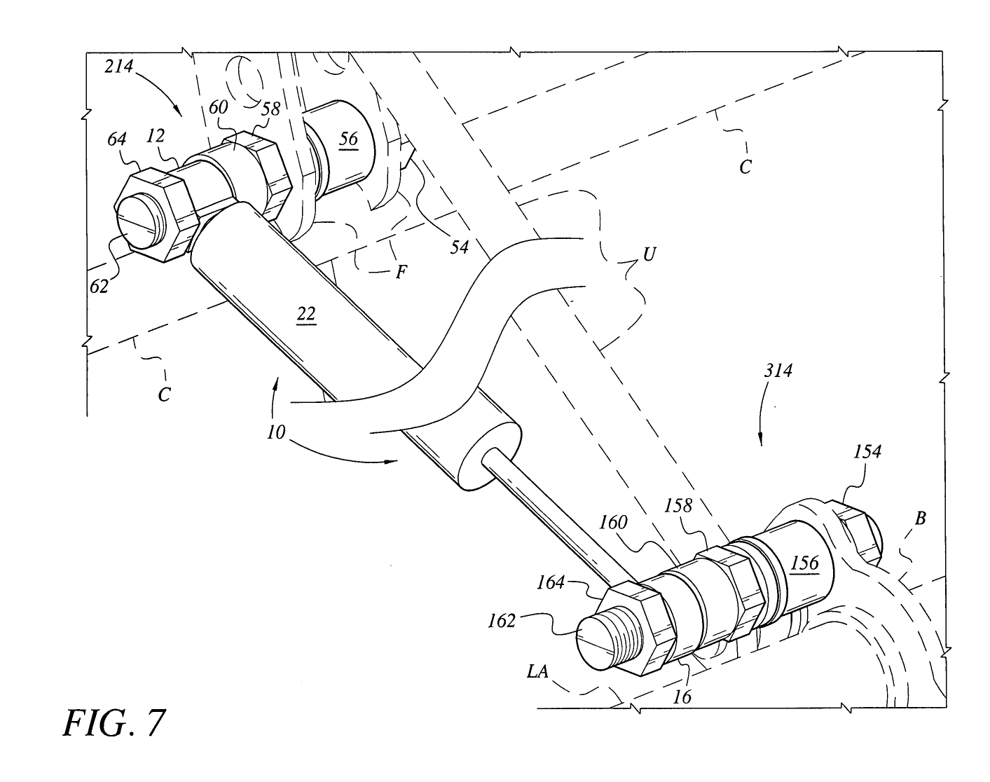

FIG. 7 provides a detailed perspective view of a forwardly mounted shock absorber 10 and yet another chassis mounting embodiment, as well as showing details of the bird cage bracket attachment assembly. The mounting or attachment assemblies for the two ends 12 and 16 of the shock absorber 10 are quite similar to one another, generally comprising lateral pins or bolts extending from their respective mounting points on the chassis and bird cage bracket.

The chassis attachment bracket assembly 214 of FIG. 7 comprises a laterally disposed pin or bolt 54, which is installed through a pair of laterally spaced plates or flanges F extending from the chassis C. Such flanges or plates F are provided for the installation of the trailing arms to the chassis C, and the plurality of mounting holes generally provided for adjustability also provides for the installation of the shock absorber attachment bolt 54 thereto. An appropriately configured bushing or spacer 56 may be installed on the bolt 54 between the two plates F, with a chassis attachment retaining nut 58 installed generally medially along the bolt 54 to secure the assembly to the plates or flanges F of the chassis C. A medial spacer or bushing 60 is installed along the bolt or pin 54, to space the shock absorber mounting lug 12 from the plate or flange structure and retaining nut 58. The bolt or pin 54 has a distal end 62 which passes through the chassis mounting lug 12 of the shock absorber 10, with a shock absorber retaining nut 64 installed on the distal end 62 of the bolt or pin 54 to capture the chassis attachment mounting lug 12 of the shock absorber 10 thereon. The bolt or pin 54 may be necked down along its length, if so required, with smaller shank and thread diameters for the medial and distal portions for mounting the shock absorber, if so required. Other components (washers, etc.), not shown, are conventionally installed with the assembly as well.

The opposite bird cage bracket attachment end 16 of the shock absorber 10 is secured to the bird cage bracket B using a lateral link assembly 314, with the lateral link assembly 314 being quite similar to the lateral bolt or pin assembly 214 used to attach the chassis attachment end 12 of the shock absorber 10 to the two plates or flanges F in FIG. 7. Identical components may be used, or their diameters and/or lengths may be adjusted as required, depending upon the installation. Essentially, the lateral link assembly 314 comprises a laterally disposed bird cage axle bracket bolt or pin 154 secured through a passage in the birdcage bracket B by a medially disposed bird cage axle bracket retaining nut 158. A spacer or bushing 156 may be installed generally medially along the bolt 154 between the nut 158 and bird cage bracket B, if required. The bird cage bracket attachment end 16 of the shock absorber 10 is secured to the distal portion 162 of the bolt or pin 154 by a shock absorber retaining nut 164, with another medially disposed spacer 160 between the medial bird cage bracket retaining nut 158 and the shock absorber end lug 16, as required for spacing and alignment.

It will be noted that the above described installation illustrated in FIG. 7 is also adaptable to rearwardly disposed shock absorbers of the present invention, i.e., the shock absorber 110 of FIG. 3, depending upon the configuration of the chassis mounting points, attachment brackets, etc. Also, as noted further above, the shock absorber 10 (or 110, in a rearwardly disposed installation) could be turned end for end in any of the installations, with the extension rod 20 adjacent to the chassis mounting point and the shock tube or body 22 adjacent to the bird cage mounting point, if so desired.

In conclusion, the present torque reaction damper provides much more positive control of the movement of the drive axle in a dirt track late model (DTLM) racing car having a rigid or solid rear drive axle. The configuration of the rear suspensions of such cars to take advantage of the driveline torque developed through the turns on the track, has resulted in relatively large rear suspension travel in such cars. While the rear axle movement provides advantageous geometries in promoting oversteer through the turns and in applying greater tractive force to the inboard tire during acceleration, the sudden change in configuration when power is reduced acts to destabilize the car and render it difficult to control during the transition. The present invention solves this problem by dampening the sudden “chassis drop” which occurs when power is suddenly reduced, as when approaching a turn. The resulting gradual change in axle position and vehicle configuration greatly facilitates control by the driver, thus making the operation of the vehicle safer and allowing the driver to carry greater speed through the maneuver, thereby reducing lap times. The adaptability of the present torque reaction damper to various locations and mounting configurations in a vehicle chassis, along with the promise of greater safety and lower lap times for competitors, will result in a highly desirable installation in virtually any DTLM type racing vehicle or other vehicles which utilize similar solid axle rear suspension systems.

It is to be understood that the present invention is not limited to the embodiments described above, but encompasses any and all embodiments within the scope of the following claims.

I claim:

1. In a vehicle having a chassis with a drive axle and at least one bird cage axle bracket installed upon the drive axle, a torque reaction damper for the drive axle, comprising:
a generally horizontally disposed telescoping shock absorber having a forwardly disposed chassis attachment end and a rearwardly disposed bird cage axle bracket attachment end opposite said chassis attachment end, said shock absorber having a soft compression and stiff extension configuration;
a chassis attachment bracket assembly connected to the chassis attachment end of said shock absorber to, the bracket being adapted for attaching said shock absorber to the vehicle chassis; and
a lateral link assembly attached to the bird cage axle bracket attachment end of said shock absorber adapted for pivotally connecting said shock absorber to the bird cage axle bracket.

2. The torque reaction damper for a drive axle according to claim 1, wherein said chassis attachment bracket assembly further comprises:
a first chassis clamp portion;
a second chassis clamp portion secured to said first chassis clamp portion adapted for securing said chassis attachment bracket assembly to the chassis;
a radially disposed arm extending from said first chassis clamp portion and having a distal end;
a rod end attachment fitting extending from the distal end of said arm, and having a rod end attachment axis normal to said rod end attachment fitting;
a rod end pivotally installed in said rod end attachment fitting;
a shock absorber attachment link extending from said rod end and having a distal end; and
a shock absorber attachment fitting extending laterally from the distal end of said shock absorber attachment link, and having a shock absorber attachment axis normal to said shock absorber attachment link.

3. The torque reaction damper for a drive axle according to claim 1, wherein said chassis attachment bracket assembly further comprises:
a first chassis clamp portion;
a second chassis clamp portion secured to said first chassis clamp portion adapted for securing said chassis attachment bracket assembly to the chassis;
a radially disposed arm extending from said first chassis clamp portion and having a distal end;
a rod end attachment bolt installed concentrically in the distal end of said arm and defining a rod end attachment axis concentric with said arm;
a rod end pivotally secured to said arm by said rod end attachment bolt;
a shock absorber attachment link extending from said rod end; and
a shock absorber attachment fitting extending laterally from said shock absorber attachment link, and having a shock absorber attachment axis normal to said shock absorber attachment link.

4. The torque reaction damper for a drive axle according to claim 1, wherein said chassis attachment bracket assembly further comprises:
a laterally disposed chassis attachment bolt affixed to the chassis, and having a distal end portion passing through the chassis attachment end of said shock absorber;
a chassis attachment retaining nut and bushing disposed generally medially upon said chassis attachment bolt, securing said chassis attachment bolt to the chassis; and
a shock absorber retaining nut disposed upon the distal end portion of said chassis attachment bolt, capturing the chassis attachment end of said shock absorber upon the distal end portion of said chassis attachment bolt.

5. The torque reaction damper for a drive axle according to claim 1, wherein said lateral link assembly further comprises:
a laterally disposed bird cage axle bracket bolt affixed to the bird cage axle bracket, and having a distal end portion passing through the bird cage axle bracket attachment end of said shock absorber;
a bird cage axle bracket retaining nut and bushing disposed generally medially upon said bird cage axle bracket bolt, securing said bird cage axle bracket bolt to the bird cage axle bracket; and
a shock absorber retaining nut disposed upon the distal end portion of said bird cage axle bracket bolt, capturing the bird cage axle bracket attachment end of said shock absorber upon the distal end portion of said bird cage axle bracket bolt.

6. In a vehicle having a chassis with a drive axle and at least one bird cage axle bracket installed upon the drive axle, a torque reaction damper for the drive axle, comprising:
a generally horizontally disposed, telescoping shock absorber having a forwardly disposed bird cage axle bracket attachment end opposite said chassis attachment end and a rearwardly disposed chassis attachment end, said shock absorber having a stiff compression and soft extension configuration;
a lateral link assembly adapted for pivotally connecting the bird cage axle bracket attachment end of said shock absorber to the bird cage axle bracket; and
a chassis attachment bracket assembly adapted for connecting the chassis attachment end of said shock absorber to the vehicle chassis.

7. The torque reaction damper for a drive axle according to claim 6, wherein said chassis attachment bracket assembly further comprises:
a first chassis clamp portion;
a second chassis clamp portion secured to said first chassis clamp portion and securing said chassis attachment bracket assembly to the chassis;
a radially disposed arm extending from said first chassis clamp portion, and having a distal end;
a rod end attachment fitting extending from said distal end of said arm, and having a rod end attachment axis normal to said rod end attachment fitting;
a rod end pivotally installed in said rod end attachment fitting;
a shock absorber attachment link extending from said rod end, and having a distal end; and
a shock absorber attachment fitting extending laterally from said distal end of said shock absorber attachment link, and having a shock absorber attachment axis normal to said shock absorber attachment link.

8. The torque reaction damper for a drive axle according to claim 6, wherein said chassis attachment bracket assembly further comprises:
a first chassis clamp portion;
a second chassis clamp portion secured to said first chassis clamp portion and securing said chassis attachment bracket assembly to the chassis;
a radially disposed arm extending from said first chassis clamp portion, and having a distal end;
a rod end attachment bolt installed concentrically in said distal end of said arm, and defining a rod end attachment axis concentric with said arm;
a rod end pivotally secured to said arm by said rod end attachment bolt;
is a shock absorber attachment link extending from said rod end; and
a shock absorber attachment fitting extending laterally from said shock absorber attachment link, and having a shock absorber attachment axis normal to said shock absorber attachment link.

9. The torque reaction damper for a drive axle according to claim 6, wherein said chassis attachment bracket assembly further comprises:
a laterally disposed chassis attachment bolt affixed to the chassis, and having a distal end portion passing through said chassis attachment end of said shock absorber;
a chassis attachment retaining nut and bushing disposed generally medially upon said chassis attachment bolt, securing said chassis attachment bolt to the chassis; and
a shock absorber retaining nut disposed upon said distal end portion of said chassis attachment bolt, capturing said chassis attachment end of said shock absorber upon said distal end portion of said chassis attachment bolt.

10. The torque reaction damper for a drive axle according to claim 6, wherein said lateral link assembly further comprises:
a laterally disposed bird cage axle bracket bolt affixed to the bird cage axle bracket, and having a distal end portion passing through said bird cage axle bracket attachment end of said shock absorber;
a bird cage axle bracket retaining nut and bushing disposed generally medially upon said bird cage axle bracket bolt, securing said bird cage axle bracket bolt to the bird cage axle bracket; and
a shock absorber retaining nut disposed upon said distal end portion of said bird cage axle bracket bolt, capturing said bird cage axle bracket attachment end of said shock absorber upon said distal end portion of said bird cage axle bracket bolt.

11. A vehicle structure, drive axle, and suspension assembly, comprising in combination:
a vehicle chassis;
a rearwardly disposed solid drive axle having a first side and a second side opposite the first side;
a differential generally medially disposed within said drive axle;
a first and a second bird cage axle bracket rotatably disposed respectively upon the first side and the second side of said drive axle;
a first axle side upper trailing arm extending between said chassis and said first bird cage axle bracket;
a first axle side lower trailing arm extending between said chassis and said first bird cage axle bracket;
a second axle side upper trailing arm extending between said chassis and said second bird cage axle bracket;
a second axle side lower trailing arm extending between said chassis and said second bird cage axle bracket;
an axle locator brace immovably affixed to said differential, and having. a forward end extending forwardly thereof;
a resilient axle locator brace attachment connecting the forward end of said axle brace to said chassis;
a generally horizontally disposed, telescoping shock absorber having a chassis attachment end and a bird cage axle bracket attachment end opposite said chassis attachment end, said shock absorber having a compression stroke and an extension stroke of substantially different resilience from one another;
a chassis attachment bracket assembly adapted for connecting the chassis attachment end of said shock absorber to said vehicle chassis;
a lateral link assembly adapted for pivotally connecting the bird cage axle bracket attachment end of said shock absorber to said bird cage axle bracket.

12. The vehicle structure, drive axle, and suspension assembly combination according to claim 11, wherein:
said shock absorber extends forwardly from said bird cage axle bracket to said chassis; and
said extension stroke of said shock absorber is substantially firmer than said compression stroke.

13. The vehicle structure, drive axle, and suspension assembly combination according to claim 11, wherein:
said shock absorber extends rearwardly from said bird cage axle bracket to said chassis; and
said extension stroke of said shock absorber is substantially softer than said compression stroke.

14. The vehicle structure, drive axle, and suspension assembly combination according to claim 11, wherein said chassis attachment bracket assembly further comprises:
a first chassis clamp portion;
a second chassis clamp portion secured to said first chassis clamp portion and securing said chassis attachment bracket assembly to said chassis;
a radially disposed arm extending from said first chassis clamp portion, and having a distal end;
a rod end attachment fitting extending from said distal end of said arm, and having a rod end attachment axis normal to said rod end attachment fitting;
a rod end pivotally installed in said rod end attachment fitting;
a shock absorber attachment link extending from said rod end, and having a distal end; and
a shock absorber attachment fitting extending laterally from said distal end of said shock absorber attachment link, and having a shock absorber attachment axis normal to said shock absorber attachment link.

15. The vehicle structure, drive axle, and suspension assembly combination according to claim 11, wherein said chassis attachment bracket assembly further comprises:
a first chassis clamp portion;
a second chassis clamp portion secured to said first chassis clamp portion and securing said chassis attachment bracket assembly to said chassis;
a radially disposed arm extending from said first chassis clamp portion, and having a distal end;
a rod end attachment bolt installed concentrically in said distal end of said arm, and defining a rod end attachment axis concentric with said arm;
a rod end pivotally secured to said arm by said rod end attachment bolt;
a shock absorber attachment link extending from said rod end; and
a shock absorber attachment fitting extending laterally from said shock absorber attachment link, and having a shock absorber attachment axis normal to said shock absorber attachment link.

16. The vehicle structure, drive axle, and suspension assembly combination according to claim 11, wherein said chassis attachment bracket assembly further comprises:
a laterally disposed chassis attachment bolt affixed to said chassis, and having a distal end portion passing through said chassis attachment end of said shock absorber;
a chassis attachment retaining nut and bushing disposed generally medially upon said chassis attachment bolt, securing said chassis attachment bolt to said chassis; and
a shock absorber retaining nut disposed upon said distal end portion of said chassis attachment bolt, capturing said chassis attachment end of said shock absorber upon said distal end portion of said chassis attachment bolt.

17. The vehicle structure, drive axle, and suspension assembly combination according to claim 11, wherein said lateral link assembly further comprises:
a laterally disposed bird cage axle bracket bolt affixed to said bird cage axle bracket, and having a distal end portion passing through said bird cage axle bracket attachment end of said shock absorber;
a bird cage axle bracket retaining nut and bushing disposed generally medially upon said bird cage axle bracket bolt, securing said bird cage axle bracket bolt to said bird cage axle bracket; and
a shock absorber retaining nut disposed upon said distal end portion of said bird cage axle bracket bolt, capturing said bird cage axle bracket attachment end of said shock absorber upon said distal end portion of said bird cage axle bracket bolt.
